(19) United States
(12) Patent Application Publication
(10) Pub. No.: US 2013/0070169 A1
(43) Pub. Date: Mar. 21, 2013

(54) TELEVISION RECEIVER AND ELECTRONIC APPARATUS

(71) Applicants: Yasuo MATSUMOTO, Tokyo (JP); Naoki TANI, Tokyo (JP)

(72) Inventors: Yasuo MATSUMOTO, Tokyo (JP); Naoki TANI, Tokyo (JP)

(73) Assignee: KABUSHIKI KAISHA TOSHIBA, Tokyo (JP)

(21) Appl. No.: 13/540,390

(22) Filed: Jul. 2, 2012

(30) Foreign Application Priority Data
Sep. 15, 2011 (JP) 2011-202412

(51) Int. Cl. H04N 5/64

(52) U.S. Cl. 348/836; 348/E05.128

(57) ABSTRACT

According to one embodiment, a television receiver includes: a housing accommodating at least a part of a display device, and comprising a mask comprising an opening through which a display screen is exposed and a cover covering the display device from a side opposite to the display screen; a support supporting the housing and comprising an area facing faces an external placement surface when placed on the external placement surface; a hinge fixed to the housing and the support, and comprising a rotating shaft, the housing and the support being rotatably connected to the hinge about the rotating shaft; a first electrical component in the housing; a second electrical component in the support; and a wire electrically connecting the first and electrical components, and fixed to the rotating shaft of the hinge with a tape at a position near the support in the housing.

### CROSS-REFERENCE TO RELATED APPLICATIONS

This application is based upon and claims the benefit of priority from Japanese Patent Application No. 2011-202412, filed on Sep. 15, 2011, the entire contents of which are incorporated herein by reference.

### FIELD

Embodiments described herein relate generally to a television receiver and an electronic apparatus.

### BACKGROUND

Conventionally widely known are electronic apparatuses in which a housing that accommodates a display device is connected to a second section in a rotatable manner via a hinge, and in which a wire connecting the inside of the housing and the second section is passed through the portion provided with the hinge.

In such an electronic apparatus including a television receiver, it is desired to prevent the wire from moving or the like near the hinge.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a television receiver according to a first embodiment viewed from the front;

FIG. 2 is an exemplary perspective view of the television receiver in the first embodiment viewed from the side;

FIG. 3 is an exemplary perspective view of a part of an internal configuration of the television receiver in the first embodiment viewed from the back;

FIG. 4 is an exemplary perspective view of an electronic apparatus according to a second embodiment in an unfolded state;

FIG. 5 is an exemplary plan view of the electronic apparatus in the second embodiment in a folded state;

FIG. 6 is an exemplary side view of the electronic apparatus in the second embodiment in the folded state;

FIG. 7 is an exemplary exploded perspective view of a part of the electronic apparatus in the second embodiment;

FIG. 8 is an exemplary exploded perspective view of another part of the electronic apparatus in the second embodiment;

FIG. 9 is an exemplary perspective view of a part of an internal configuration of the portion illustrated in FIG. 8 viewed from a side opposite to the side in FIG. 7 in the second embodiment;

FIG. 10 is an exemplary perspective view of a part of an internal configuration of the portion illustrated in FIG. 7 viewed from a side opposite to the side in FIG. 8 in the second embodiment;

FIG. 11 is an exemplary perspective view of a hinge cover of the electronic apparatus in the second embodiment;

FIG. 12 is an exemplary perspective view of the hinge cover illustrated in FIG. 11 viewed from another angle in the second embodiment;

FIG. 13 is an exemplary perspective view of a state in which a tape is stuck to a housing (a state before a harness is fixed with the tape) when the electronic apparatus in the second embodiment is being assembled;

FIG. 14 is an exemplary side view of the tape of the electronic apparatus in the second embodiment;

FIG. 15 is an exemplary sectional view along line XV-XV in FIG. 4 in the second embodiment;

FIG. 16 is an exemplary sectional view along line XVI-XVI in FIG. 5 in the second embodiment;

FIG. 17 is an exemplary perspective view of a part of a member that constitutes a first housing of the electronic apparatus in the second embodiment viewed from the inside of the housing; and

FIG. 18 is an exemplary perspective view of a part of another member that constitutes the first housing of the electronic apparatus in the second embodiment, and that is combined with the member illustrated in FIG. 17 viewed from the inside of the housing.

### DETAILED DESCRIPTION

In general, according to one embodiment, a television receiver comprises: a display device comprising a display screen; a housing configured to accommodate at least a part of the display device, the housing comprising a mask section and a cover section, the mask section comprising an opening through which the display screen is exposed, the cover section covering the display device from a side opposite to the display screen; a support comprising an area facing faces an external placement surface when the support is placed on the external placement surface, the support being configured to support the housing; a hinge fixed to the housing and the support, the hinge comprising a rotating shaft, the housing and the support being rotatably connected to the hinge about the rotating shaft; a first electrical component accommodated in the housing; a second electrical component accommodated in the support; and a wire configured to electrically connect the first electrical component and the second electrical component, the wire being fixed to the rotating shaft of the hinge with a tape at a position near the support in the housing.

Exemplary embodiments and modifications described below comprise components similar to each other. Therefore, in the description below, common numerals are assigned to similar components, and overlapping explanation thereof will be omitted.

In the embodiments below, an electronic apparatus is embodied as a television receiver or a so-called notebook personal computer, for example. However, the electronic apparatus according to the present embodiments is not limited thereto. The electronic apparatus according to the present embodiments can be embodied as an electronic apparatus comprising two sections connected to each other in a rotatable manner by a hinge, such as a smart television, a mobile phone, an image display, and a video phone.

### First Embodiment

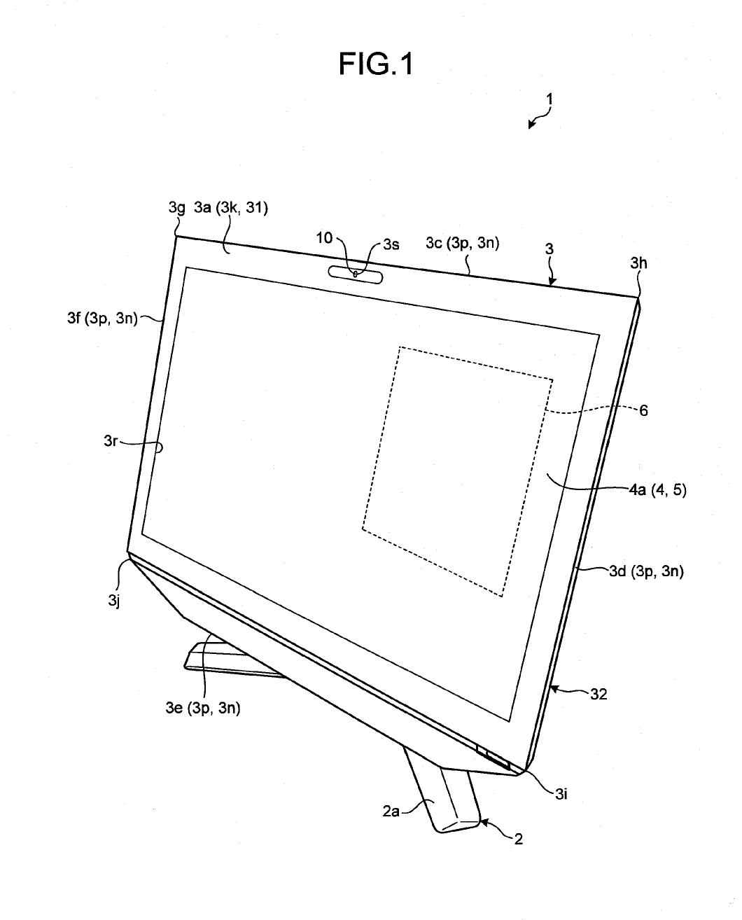

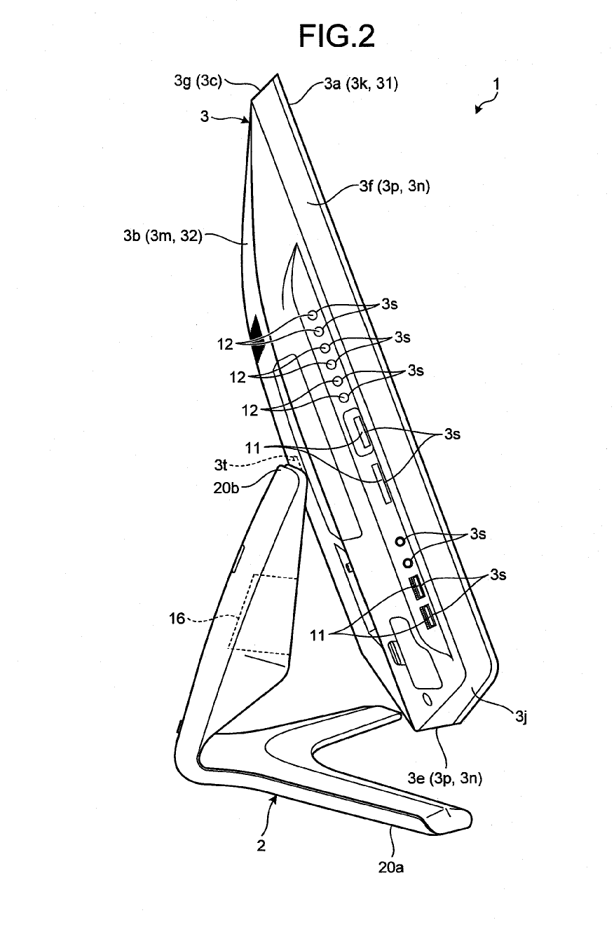

In the present embodiment, for example, a television receiver 1 comprises a support 2 and a housing 3 as illustrated in FIGS. 1 and 2. Specifically, the housing 3 (a first housing, a first section, or a first component) accommodates at least a part of a display device 4. The support 2 (a stand, a platform, a support section, a second housing, a second section, another section, or another component) supports the housing 3. The support 2 comprises an area 20a (a bottom wall, a wall, an area, a section, a rubber leg, or a leg) that faces an external placement surface when the support 2 is placed on the external placement surface.

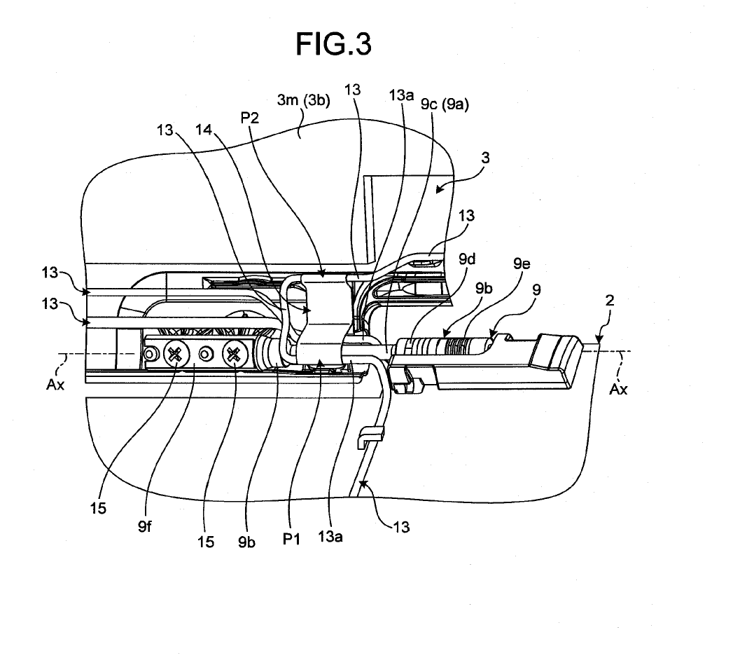

In the present embodiment, for example, the support 2 supports the housing 3 in a rotatable manner via a hinge 9 (a connector, a coupler, a rotation supporter, a hinge mechanism, a connecting mechanism, a coupling mechanism, or a rotation supporting mechanism, refer to FIG. 3). In other words, the hinge 9 connects (couples) the support 2 and the housing 3 in a rotatable manner. In the present embodiment, for example, the hinge 9 changes the angle of a display screen 4a in the vertical direction. In other words, the hinge 9 can adjust a tilt. The support 2 can support the housing 3 so as to allow the housing 3 to rotate (pivot or swivel, for example) in another direction.

In the present embodiment, for example, the housing 3 of the television receiver 1 is formed in a rectangular shape (an oblong shape in the present embodiment, for example) viewed from the front and the back as illustrated in FIG. 1. Furthermore, in the present embodiment, for example, the housing 3 is formed in a flat rectangular parallelepiped shape that has a small width in the front-back direction as illustrated in FIG. 2. The housing 3 comprises a surface 3a (a front surface, a front face, a first surface, or a first surface portion) and a surface 3b (a rear surface, a back surface, a second surface, or a second surface portion) opposite thereto. The surface 3a and the surface 3b are approximately parallel to each other. Furthermore, as illustrated in FIG. 1, the housing 3 comprises four ends 3c to 3f (sides or edges) and four corners 3g to 3j (peaks, curves, or ends) viewed from the front. The ends 3c and 3e are examples of a long side, and the ends 3d and 3f are examples of a short side.

The housing 3 further comprises a wall 3k (a first section, a plate, a frame, a front wall, a face wall, or a top wall) comprising the surface 3a and a wall 3m (a second section, a plate, a rear wall, a back wall, or a bottom wall, refer to FIG. 2) comprising the surface 3b. The walls 3k and 3m are in a rectangular shape (an oblong shape in the present embodiment, for example). Furthermore, the housing 3 comprises four walls 3n (third sections, plates, side walls, end walls, standing walls, or extending portions) comprising a surface 3p (a side surface, a peripheral surface, or a third surface) extending between the wall 3k and the wall 3m. The wall 3k has an opening 3r in a rectangular shape, for example. Therefore, the wall 3k is in a rectangular shape and a frame shape.

Furthermore, the housing 3 can be configured by combining a plurality of components (divided parts). In the present embodiment, for example, the housing 3 comprises a first housing member 31 (a first section, a front side member, a mask, a mask section, a cover, a front cover, a cover section, or a first area) containing at least the wall 3k and a second housing member 32 (a second section, a rear side member, a base, a base section, a bottom, a bottom section, a cover, a rear cover, a cover section, or a second area) containing at least the wall 3m. The wall 3n is contained in at least one of the first housing member 31 and the second housing member 32 (e.g., in the second housing member 32). Furthermore, the housing 3 can comprise the following housing members arranged between the first housing member 31 and the second housing member 32 in addition to the first housing member 31 and the second housing member 32: a third housing member (a third section, a middle member, a dividing member, a barrier member, a wall member, an intervening member, an inner plate, a middle plate, a middle frame, or a third area, which is not illustrated); a fourth housing member (a fourth section, a middle member, a dividing member, a barrier member, a wall member, an intervening member, a covering member, a shield, or a fourth area, which is not illustrated); and the like.

The housing 3 can be made of a metal material, a synthetic resin material, and the like. The first housing member 31 and the second housing member 32 can be made of a material having relatively low rigidity (a material having lower rigidity than those of the third housing member and the fourth housing member, such as a synthetic resin material). Portions facing the inside of the housing 3 in the first housing member 31 and the second housing member 32 can comprise a wall (a protruding portion or a protruding wall, which is not illustrated) such as a rib. The wall can make the rigidity of the housing 3 higher.

In the present embodiment, for example, a connector 11 and an operating module 12 can be provided to the surface 3b and the surface 3p of the housing 3 as illustrated in FIG. 2. The connector 11 can be a connector for a power cable, a universal serial bus (USB) connector, a card connector, or a connector for earphones and a microphone, for example. The operating module 12 can be a push button, a push switch, a slide switch, a pointing device, or a dial, for example. Furthermore, as illustrated in FIG. 1, a camera module 10 (a camera or an imaging device) can be provided to the surface 3a. The connector 11, the operating module 12, the camera module 10, and the like are exposed through openings 3s provided to the walls 3k, 3m, and 3n of the housing 3.

In the present embodiment, for example, the display screen 4a arranged on the surface 3a side of the display device 4 (a display module, a display, or a panel) is exposed forward (outside) of the housing 3 through the opening 3r as illustrated in FIG. 1. A user can visually recognize the display screen 4a from the front side through the opening 3r. The display device 4 is formed in a rectangular shape (an oblong shape in the present embodiment, for example) viewed from the front. Furthermore, the display device 4 is formed in a flat rectangular parallelepiped shape that has a small width in the front-back direction. The display device 4 is a liquid crystal display (LCD) or an organic electro-luminescent display (GELD), for example.

In the present embodiment, for example, the front side (face side or wall 3k side) of the display device 4 is provided with an input operation panel 5 (e.g., a touch panel, a touch sensor, and an operation surface). The input operation panel 5 is transparent and is formed in a relatively thin rectangular shape, and covers the display screen 4a. An operator (e.g., a user) uses his/her finger or a component (e.g., a stylus, which is not illustrated) to perform an operation, such as a touch, a press, a slide, and a motion of the finger, the stylus, or the like near the input operation panel 5, with respect to the input operation panel 5, thereby performing input processing. Furthermore, light output from the display screen 4a of the display device 4 passes through the input operation panel 5, and is output forward (outside) of the housing 3 through the opening 3r of the wall 3k. The input operation panel 5 is an example of an input module.

In the present embodiment, for example, one or more boards 6 (circuit boards, control boards, main boards, electrical components, or first electrical components) are accommodated on the rear side (other side, back side, wall 3m side, or side opposite to the display screen 4a) of the display device 4 in the housing 3 as illustrated in FIG. 1. The board 6 is provided in a manner parallel to the display device 4. The board 6 is provided in a manner separated from the walls 3k, 3m, 3n, and the like, that is, with a space (a gap) interposed between the board 6 and the walls 3k, 3m, 3n, and the like.

In the present embodiment, for example, a plurality of components (not illustrated) can be mounted on the board 6. Examples of the components include a central processing unit (CPU), a graphic controller, a power circuit component, a platform controller hub (PCH), a memory slot connector, an LCD connector, an input/output (I/O) connector, a power coil, an element, and a connector. A control circuit can comprise an image signal processing circuit, a tuner, a high-definition multimedia interface (HDMI) signal processor, an audio video (AV) input terminal, a remote-control signal receiver, a controller, a selector, an on-screen display interface, a storage module (e.g., a read-only memory (ROM), a random access memory (RAM), a hard disk drive (HDD), and a solid state drive (SSD)), and a voice signal processing circuit, for example. The control circuit controls output of an image (a moving image, a still image, or the like) by the display screen 4a of the display device 4, output of sound by a speaker (not illustrated), emission of light by a light emitting diode (LED, which is not illustrated), for example. The display device 4, the speaker, the LED, and the like are examples of an output module.

In the present embodiment, for example, the support 2 supports a rear portion (a back portion or the wall 3m) on the side opposite to the display screen 4a of the housing 3 in a rotatable manner via the hinge 9. Specifically, for example, the hinge 9 comprises a first section 9a that is relatively thin (thinner than a second section 9b) and the second section 9b that is relatively thick (thicker than the first section 9a) as illustrated in FIG. 3. The hinge 9 further comprises a shaft 9c (a rotating shaft or a rotary shaft), a supporter 9d, a resistant element 9e, and a connector 9f, and the like. The shaft 9c extends between the support 2 and the housing 3. The supporter 9d is provided to one of the support 2 and the housing 3 (to the support 2 in the present embodiment, for example), and supports the shaft 9c in a rotatable manner about an axis (a central axis or a rotation axis Ax) extending along the longitudinal direction of the shaft 9c. The resistant element 9e is interposed between the shaft 9c and the supporter 9d, and applies frictional force to the shaft 9c and the supporter 9d. The connector 9f is provided to the shaft 9c, and connects the shaft 9c to the other of the support 2 and the housing 3 (to the housing 3 in the present embodiment, for example). The support 2 is connected to one of the support 2 and the housing 3 (to the support 2 in the present embodiment, for example) via a connecting section, which is not illustrated. The hinge 9 configured in this manner connects the support 2 and the housing 3 in a rotatable manner about the rotation axis Ax illustrated in FIG. 3. The hinge 9 is covered with covers 20b and 3t provided to the wall 3m and the support 2. FIG. 3 illustrates a state created by removing the covers 20b and 3t.

In the present embodiment, for example, a harness 13 (a wire) is arranged in a manner extending from the inside of the support 2 to the inside of the housing 3 as illustrated in FIG. 3. Specifically, for example, the harness 13 electrically connects the board 6 (an electrical component or a circuit) in the housing 3, an electrical component (an electronic component, which is not illustrated) mounted on the board 6, and an electrical component (not illustrated) that is accommodated in the housing 3 and is not mounted on the board 6 to an electrical component (e.g., a speaker 16 (refer to FIG. 2)) provided to the support 2. The harness 13 passes through an opening (not illustrated) into which the hinge 9 is inserted in the support 2 and the housing 3. In other words, the harness 13 is arranged along the peripheral surface of the shaft 9c of the hinge 9. The electrical components of the support 2 include the speaker 16, a connector for external connection (not illustrated), a microphone, a camera, a lamp, a light-emitting element, and an operating module (e.g., a switch).

In the present embodiment, for example, the harness 13 is fixed to the hinge 9 with a tape 14 (a holding section, a supporter, a holding component, a connecting component, or a holder) as illustrated in FIG. 3. In the present embodiment, for example, the tape 14 bundles the shaft 9c and one or more harnesses 13 arranged around the shaft 9c together from the periphery thereof. Therefore, according to the present embodiment, the harness 13 is prevented from moving near the hinge 9, for example. As a result, it is possible to prevent the harness 13 from being exposed or protruding outward from a boundary (the opening) between the support 2 and the housing 3, for example.

In the present embodiment, for example, the tape 14 fixes a portion 13a extending along the longitudinal direction of the hinge 9 (shaft 9c). Therefore, according to the present embodiment, it is possible to fix the harness 13 to the shaft 9c with the tape 14 more securely, for example.

In the present embodiment, for example, the tape 14 fixes the plurality of harnesses 13 arranged along the periphery of the shaft 9c to the shaft 9c. Therefore, according to the present embodiment, it is possible to arrange the harnesses 13 around the shaft 9c more compactly, for example.

In the present embodiment, for example, the tape 14 fixes the harness 13 at a position (a second position P2) distant from the shaft 9c. Therefore, according to the present embodiment, it is possible to use the tape 14 for fixing (holding) the harness 13 arranged away from the shaft 9c, for example.

In the present embodiment, for example, the tape 14 fixes the harness 13 at a first position P1 near the shaft 9c and at the second position P2 distant from the shaft 9c. Therefore, according to the present embodiment, it is possible to reduce the number of components compared with the case where the harness 13 is fixed with different fixing parts (holding sections), for example. Furthermore, it is possible to reduce trouble when assembling the harness 13, for example.

In the present embodiment, for example, the harness 13 is bent between the first position P1 and the second position P2. Therefore, it is possible to fix (hold) the harness 13 extending from a second electrical component of the support 2 to the first electrical component of the housing 3 with one tape 14. In the harness 13, an extending direction at the first position P1 (a direction along the shaft 9c, that is, the left direction in the example of FIG. 3) is different from (opposite to, in the present embodiment, for example) an extending direction at the second position P2 (the right direction in the example of FIG. 3).

In the present embodiment, for example, the tape 14 is fixed to the first section 9a (shaft 9c) thinner than the second section 9b. Therefore, according to the present embodiment, it is possible to prevent the area in which the harness 13 is fixed to the hinge 9 from becoming larger (becoming bulky), for example. Accordingly, it is possible to increase the flexibility in the layout of the components in the housing 3 and the support 2, for example.

### Second Embodiment

In the present embodiment, for example, an electronic apparatus 1A comprises a first housing 3A and a second housing 2A. Specifically, the first housing 3A (first section) accommodates at least a part of the display device 4. The second housing 2A accommodates a board 6A. The second housing 2A comprises a keyboard 7 (an input operating module, a first input operating module, an input receiving module, or an input module), a pointing device 8a (an input operating module, a second input operating module, an input receiving module, or an input module), a click button 8b (an input operating module, a third input operating module, an input receiving module, or an input module), and the like.

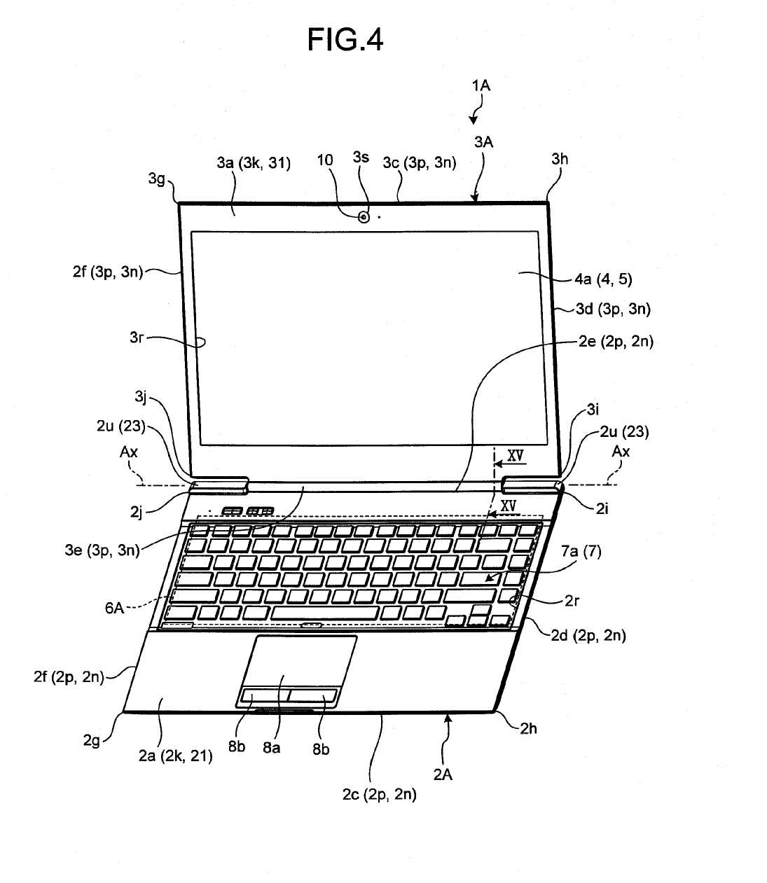

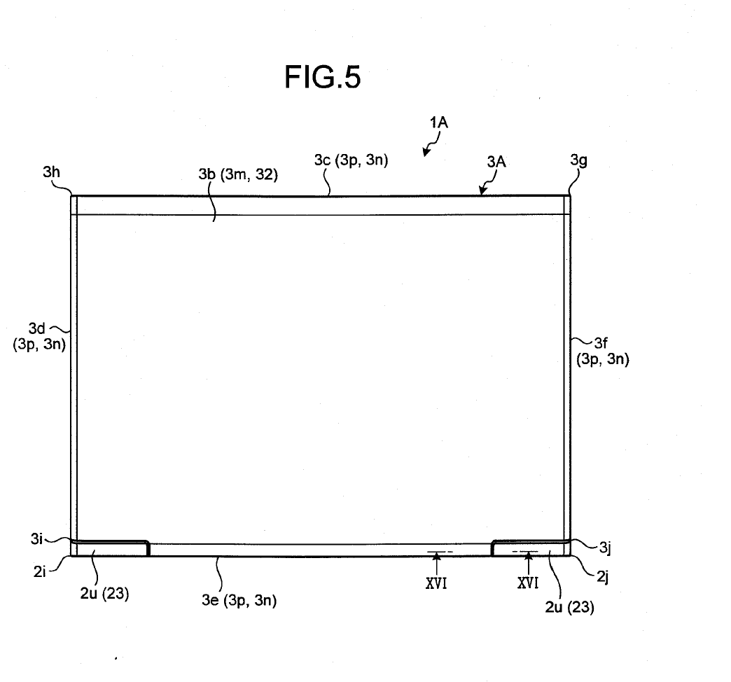

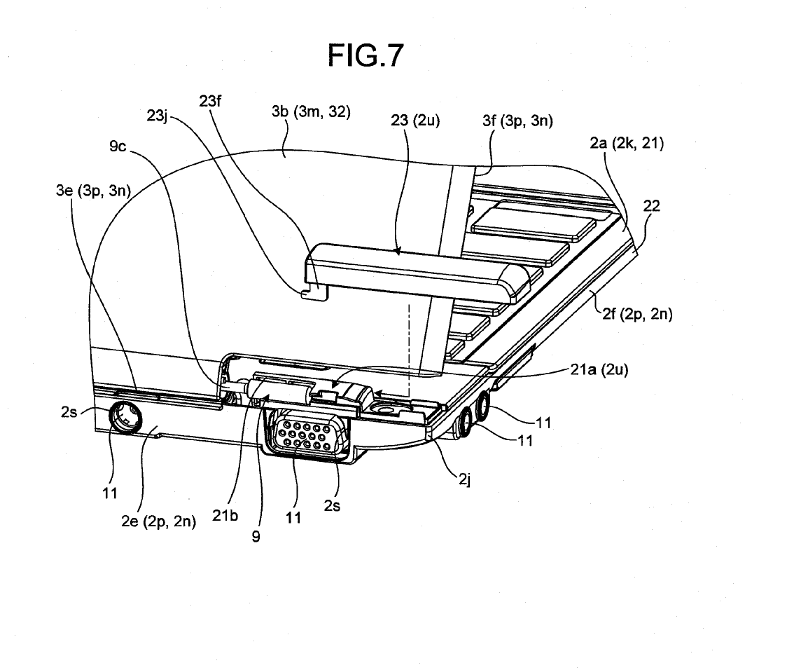

The first housing 3A and the second housing 2A are connected in a rotatable manner by the hinge 9 (a connection, a coupler, a rotation supporter, a hinge mechanism, a connecting mechanism, a coupling mechanism, or a rotation supporting mechanism, refer to FIGS. 7 to 10). The first housing 3A and the second housing 2A are connected by the hinge 9 in a rotatable manner between at least an unfolded state illustrated in FIG. 4 and a folded state illustrated in FIG. 5. In the present embodiment, for example, the hinge 9 connects the first housing 3A and the second housing 2A in a rotatable manner about a rotation axis Ax. The display screen 4a of the display device 4 is exposed through the opening 3r provided to the surface 3a (a front surface, a front face, a first surface, or a first surface portion) of the first housing 3A. The keyboard 7, the pointing device 8a, the click button 8b, and the like are exposed on a surface 2a (an upper surface, a front face, a first surface, or a first surface portion) of the second housing 2A. In the folded state, the surface 3a of the first housing 3A and the surface 2a of the second housing 2A overlap with each other. As a result, the display screen 4a, the keyboard 7, the pointing device 8a, the click button 8b, and the like are hidden by the first housing 3A and the second housing 2A. By contrast, in the unfolded state, the surface 3a of the first housing 3A and the surface 2a of the second housing 2A are exposed. As a result, the display screen 4a, the keyboard 7, the pointing device 8a, the click button 8b, and the like can be used (can be visually recognized or can be operated).

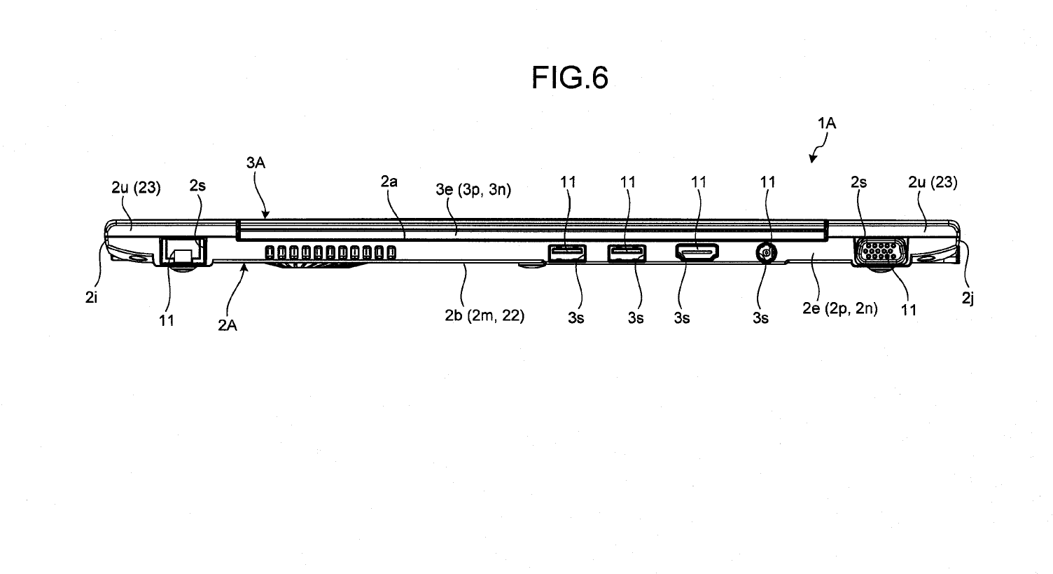

In the present embodiment, for example, the first housing 3A is formed in a rectangular shape (an oblong shape in the present embodiment, for example) viewed from the front and the back as illustrated in FIGS. 4 and 5. Furthermore, in the present embodiment, for example, the first housing 3A is formed in a flat rectangular parallelepiped shape that has a small width in the front-back direction as illustrated in FIG. 6. The first housing 3A comprises the surface 3a (a front surface, a front face, a first surface, or a first surface portion) and the surface 3b (a rear surface, a back surface, a second surface, or a second surface portion) opposite thereto. The surface 3a and the surface 3b are approximately parallel to each other. Furthermore, as illustrated in FIG. 4, the first housing 3A comprises the four ends 3c to 3f (sides or edges) and the four corners 3g to 3j (peaks, curves, or ends) viewed from the front. The ends 3c and 3e are examples of a long side, and the ends 3d and 3f are examples of a short side.

The first housing 3A further comprises the wall 3k (a first section, a plate, a frame, a front wall, a face wall, or a top wall) comprising the surface 3a and a wall 3m (a second section, a plate, a rear wall, a back wall, or a bottom wall) comprising the surface 3b. The walls 3k and 3m are in a rectangular shape (an oblong shape in the present embodiment, for example). Furthermore, the first housing 3A comprises the four walls 3n (third sections, plates, side walls, end walls, standing walls, or extending portions) comprising the surface 3p (a side surface, a peripheral surface, or a third surface) extending between the wall 3k and the wall 3m. The wall 3k has an opening 3r in a rectangular shape, for example. Therefore, the wall 3k is in a rectangular shape and a frame shape.

Furthermore, the first housing 3A can be configured by combining a plurality of components (divided parts). In the present embodiment, for example, the first housing 3A comprises the first housing member 31 (a first section, a front side member, a mask, a mask section, a cover, a front cover, a cover section, or a first area) containing at least the wall 3k and the second housing member 32 (a second section, a rear side member, a base, a base section, a bottom, a bottom section, a cover, a rear cover, a cover section, or a second area) containing at least the wall 3m. The wall 3n is contained in at least one of the first housing member 31 and the second housing member 32 (e.g., in the second housing member 32). Furthermore, the first housing 3A can comprise the following housing members arranged between the first housing member 31 and the second housing member 32 in addition to the first housing member 31 and the second housing member 32: a third housing member (a third section, a middle member, a dividing member, a barrier member, a wall member, an intervening member, an inner plate, a middle plate, a middle frame, or a third area, which is not illustrated); a fourth housing member (a fourth section, a middle member, a dividing member, a barrier member, a wall member, an intervening member, a covering member, a shield, or a fourth area, which is not illustrated); and the like.

The first housing 3A can be made of a metal material, a synthetic resin material, and the like. The first housing member 31 and the second housing member 32 can be made of a material having relatively low rigidity (a material having lower rigidity than those of the third housing member and the fourth housing member, such as a synthetic resin material). Portions facing the inside of the first housing 3A in the first housing member 31 and the second housing member 32 can comprise a wall (a protruding portion or a protruding wall, which is not illustrated) such as a rib. The wall can make the rigidity of the first housing 3A higher.

In the present embodiment, for example, the camera module 10 (a camera or an imaging device) can be provided to the surface 3a of the first housing 3A as illustrated in FIG. 4. The camera module 10 and the like are exposed through the openings 3s provided to the wall 3k of the first housing 3A. A connector and an operating module can be provided to the surface 3p of the first housing 3A.

In the present embodiment, for example, the display screen 4a arranged on the surface 3a side of the display device 4 (a display module, a display, or a panel) is exposed forward (outside) of the first housing 3A through the opening 3r as illustrated in FIG. 4. A user can visually recognize the display screen 4a from the front side through the opening 3r. The display device 4 is formed in a rectangular shape (an oblong shape in the present embodiment, for example) viewed from the front. Furthermore, the display device 4 is formed in a flat rectangular parallelepiped shape that has a small width in the front-back direction. The display device 4 is an LCD or an GELD, for example.

In the present embodiment, for example, the front side (face side or wall 3k side) of the display device 4 is provided with the input operation panel 5 (e.g., a touch panel, a touch sensor, and an operation surface). The input operation panel 5 is transparent and is formed in a relatively thin rectangular shape, and covers the display screen 4a. An operator (e.g., a user) uses his/her finger or a component (e.g., a stylus, which is not illustrated) to perform an operation, such as a touch, a press, a slide, and a motion of the finger, the stylus, or the like near the input operation panel 5, with respect to the input operation panel 5, thereby performing input processing. Furthermore, light output from the display screen 4a of the display device 4 passes through the input operation panel 5, and is output forward (outside) of the first housing 3A through the opening 3r of the wall 3k. The input operation panel 5 is an example of an input module.

In the present embodiment, for example, the second housing 2A is formed in a rectangular shape (an oblong shape in the present embodiment, for example) viewed from the front and the back as illustrated in FIGS. 4 and 5. Furthermore, in the present embodiment, for example, the second housing 2A is formed in a flat rectangular parallelepiped shape that has a small width in the front-back direction as illustrated in FIG. 6. The second housing 2A comprises the surface 2a (an upper surface, a front face, a first surface, or a first surface portion) and a surface 2b (a lower surface, aback surface, a second surface, or a second surface portion) opposite thereto. The surface 2a and the surface 2b are approximately parallel to each other. Furthermore, as illustrated in FIG. 4, the second housing 2A comprises four ends 2c to 2f (sides or edges) and four corners 2g to 2j (peaks, curves, or ends) viewed from the front. The ends 2c and 2e are examples of a long side, and the ends 2d and 2f are examples of a short side.

The second housing 2A further comprises a wall 2k (a first section, a plate, a frame, a front wall, a face wall, or a top wall) comprising the surface 2a and a wall 2m (a second section, a plate, a rear wall, a back wall, or a bottom wall, refer to FIG. 6) comprising the surface 2b. The walls 2k and 2m are in a rectangular shape (an oblong shape in the present embodiment, for example). Furthermore, the second housing 2A comprises four walls 2n (third sections, plates, side walls, end walls, standing walls, or extending portions) comprising a surface 2p (a side surface, a peripheral surface, or a third surface) extending between the wall 2k and the wall 2m. The wall 2k has an opening 2r in a rectangular shape, for example. Therefore, the wall 2k is in a rectangular shape and a frame shape.

Furthermore, the second housing 2A can be configured by combining a plurality of components (divided parts). In the present embodiment, for example, the second housing 2A comprises a first housing member 21 (a first section, a front side member, a mask, a mask section, a cover, a front cover, a cover section, or a first area, refer to FIG. 4) containing at least the wall 2k and a second housing member 22 (a second section, a rear side member, a base, a base section, a bottom, a bottom section, a cover, a rear cover, a cover section, or a second area, refer to FIG. 6) containing at least the wall 2m. The wall 2n is contained in at least one of the first housing member 21 and the second housing member 22 (e.g., in the second housing member 22). Furthermore, the second housing 2A can comprise the following housing members arranged between the first housing member 21 and the second housing member 22 in addition to the first housing member 21 and the second housing member 22: a third housing member (a third section, a middle member, a dividing member, a barrier member, a wall member, an intervening member, an inner plate, a middle plate, a middle frame, or a third area, which is not illustrated); a fourth housing member (a fourth section, a middle member, a dividing member, a barrier member, a wall member, an intervening member, a covering member, a shield, or a fourth area, which is not illustrated); and the like.

The second housing 2A can be made of a metal material, a synthetic resin material, and the like. The first housing member 21 and the second housing member 22 can be made of a material having relatively low rigidity (a material having lower rigidity than those of the third housing member and the fourth housing member, such as a synthetic resin material). Portions facing the inside of the second housing 2A in the first housing member 21 and the second housing member 22 can comprise a wall (a protruding portion or a protruding wall, which is not illustrated) such as a rib. The wall can make the rigidity of the second housing 2A higher.

In the present embodiment, for example, the connector 11 can be provided to the surface 2p of the second housing 2A as illustrated in FIG. 6. The connector 11 can be a connector for a power cable, a USB connector, a card connector, or a connector for earphones and a microphone, for example. The connector 11 is exposed through an opening 2s provided to the wall 2n of the second housing 2A. A connector and an operating module can be provided to the surface 2a of the second housing 2A.

In the present embodiment, for example, an operation surface 7a (a surface or an upper surface) of the keyboard 7 is exposed forward (outside) of the second housing 2A through the opening 2r as illustrated in FIG. 4. On the surface 2a, the keyboard 7 is arranged close to the end 2e side, whereas the pointing device 8a and the click button 8b are arranged close to the end 2c side opposite to the end 2e. The end 2e is positioned on the back side in the depth direction (front-back direction), whereas the end 2c is positioned on the front side.

In the present embodiment, for example, one or more boards 6A (circuit boards, control boards, main boards, electrical components, or first electrical components) are accommodated on the rear side (other side, back side, wall 2m side, or side opposite to the operation surface 7a) of the keyboard 7 in the second housing 2A as illustrated in FIG. 4. The board 6A is provided in a manner parallel to the keyboard 7. The board 6A is provided in a manner separated from the walls 2k, 2m, 2n, and the like, that is, with a space (a gap) interposed between the board 6A and the walls 2k, 2m, 2n, and the like.

In the present embodiment, for example, a plurality of components (not illustrated) can be mounted on the board 6A. Examples of the components include a CPU, a graphic controller, a power circuit component, a PCH, a memory slot connector, an LCD connector, an I/O connector, a power coil, an element, and a connector. A control circuit can comprise an image signal processing circuit, a tuner, an HDMI signal processor, an AV input terminal, a remote-control signal receiver, a controller, a selector, an on-screen display interface, a storage module (e.g., a ROM, a RAM, an HDD, and an SSD), and a voice signal processing circuit, for example. The control circuit controls output of an image (a moving image, a still image, or the like) by the display screen 4a of the display device 4, output of sound by a speaker (not illustrated), emission of light by an LED (not illustrated), for example. The display device 4, the speaker, the LED, and the like are examples of an output module.

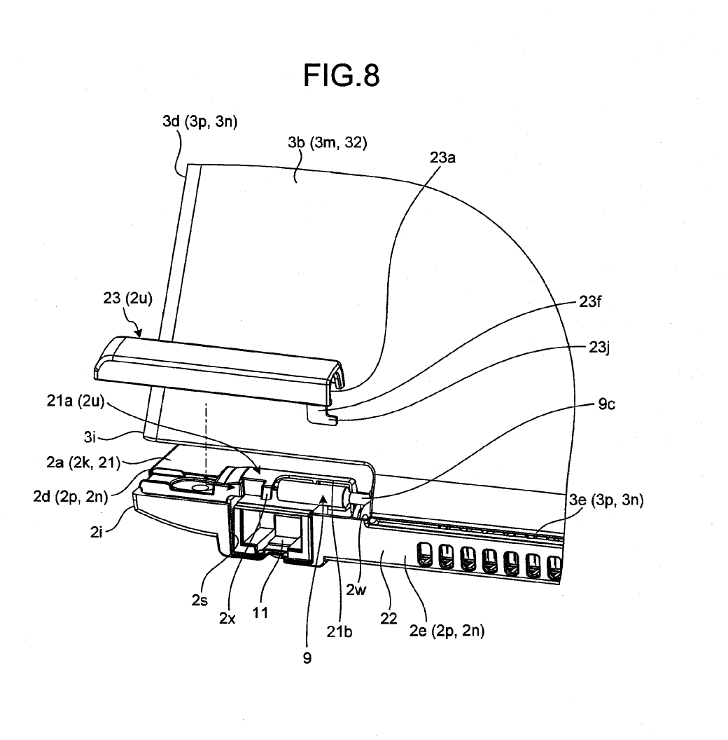

In the present embodiment, for example, protruding portions 2u protruding from the surface 2a in the thickness direction are provided to both ends in the longitudinal direction of the end 2e of the second housing 2A as illustrated in FIGS. 4 and 6. In the present embodiment, for example, the protruding portion 2u accommodates a part of the hinge 9 (a section arranged on the second housing 2A side) as illustrated in FIGS. 7 and 8. Furthermore, in the present embodiment, for example, the connector 11 that is higher (thicker) than other connectors 11 is provided in a manner corresponding to the protruding portion 2u as illustrated in FIG. 6. In the present embodiment, for example, the hinge 9 is provided adjacent to the connector 11 in the protruding portion 2u as illustrated in FIG. 8. Furthermore, as illustrated in FIGS. 6 to 8, a hinge cap 23 is provided adjacent to the connector 11. Therefore, it is possible to reduce the height (thickness) of the portion to which the high (thick) connector 11 is provided in the electronic apparatus 1A compared with the case where the wall of the second housing 2A is interposed between the connector 11 and the hinge 9 or between the connector 11 and the hinge cap 23. Furthermore, the protruding portion 2u that accommodates the hinge 9 is covered with the hinge cap 23 (a cover, a cap, a covering section, a covering member, or a fifth housing member) that is a different component from the first housing member 21 and the second housing member 22. With this configuration, it is possible to divide a process for assembling (attaching or handling) the first housing member 21 or the second housing member 22 from a process for assembling (attaching or handling) components (the hinge 9, the connector 11, and the harness 13) around the hinge 9, for example. Therefore, for example, it is possible to reduce trouble when manufacturing the electronic apparatus 1A. Furthermore, by applying decoration different from that for other portions (general portions, that is, the first housing members 21 and 31 and the second housing members 22 and 32) to the hinge cap 23, it is possible to add an accent to the appearance. Such decoration includes painting of the surface (external surface) of the hinge cap 23 with a metallic paint. Furthermore, with attachment and detachment or exchange of the hinge cap 23 by sliding the hinge cap 23 and using a fixture, which will be described later, and selection of the hinge cap 23, it is possible to change the appearance into an appearance favored by the user, for example.

In the present embodiment, for example, a protruding portion 21a (a wall, a rib, a supporter, or an inner member) is provided to at least one of the first housing member 21 and the second housing member 22 (to the first housing member 21 in the present embodiment, for example) as illustrated in FIGS. 7 and 8. The protruding potion 21a is arranged side by side with the hinge 9, and is higher than the hinge 9. Therefore, by covering the protruding portion 21a with the hinge cap 23, it is possible to prevent the hinge cap 23 from interfering with the hinge 9. An edge 21b of the protruding portion 21a is formed as a cutout. The edge 21b is an example of an opening through which the hinge 9 is exposed.

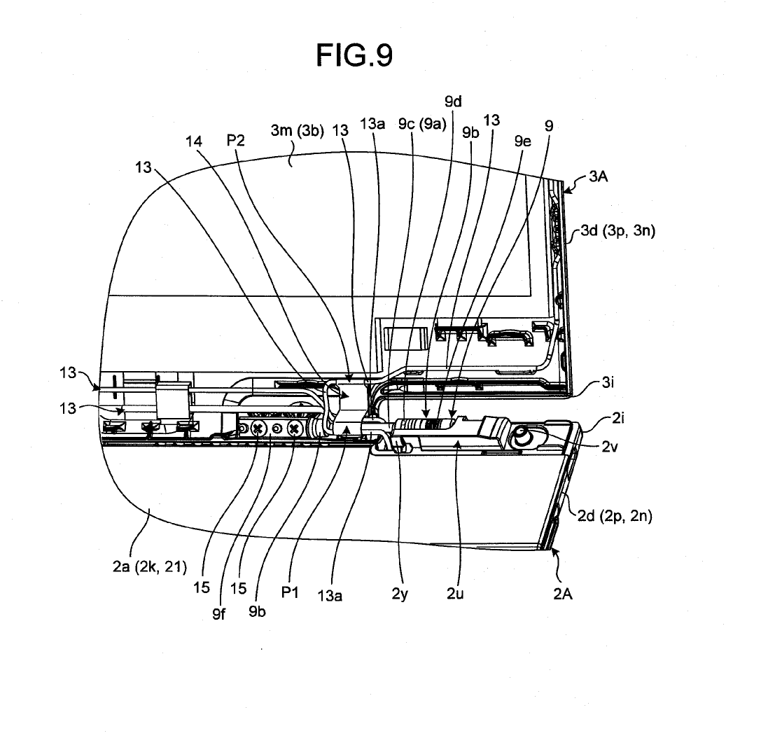

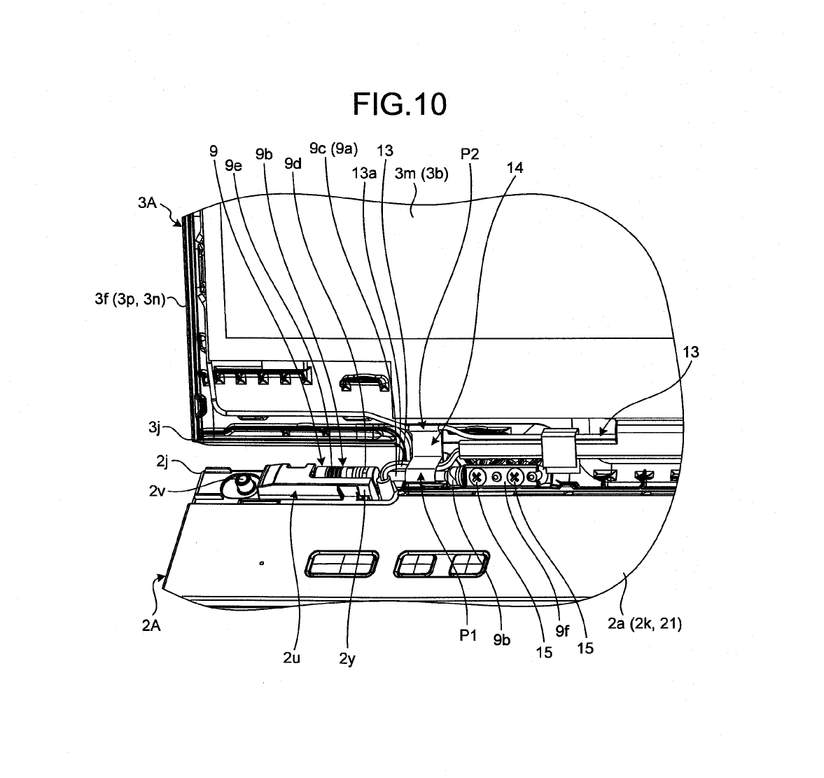

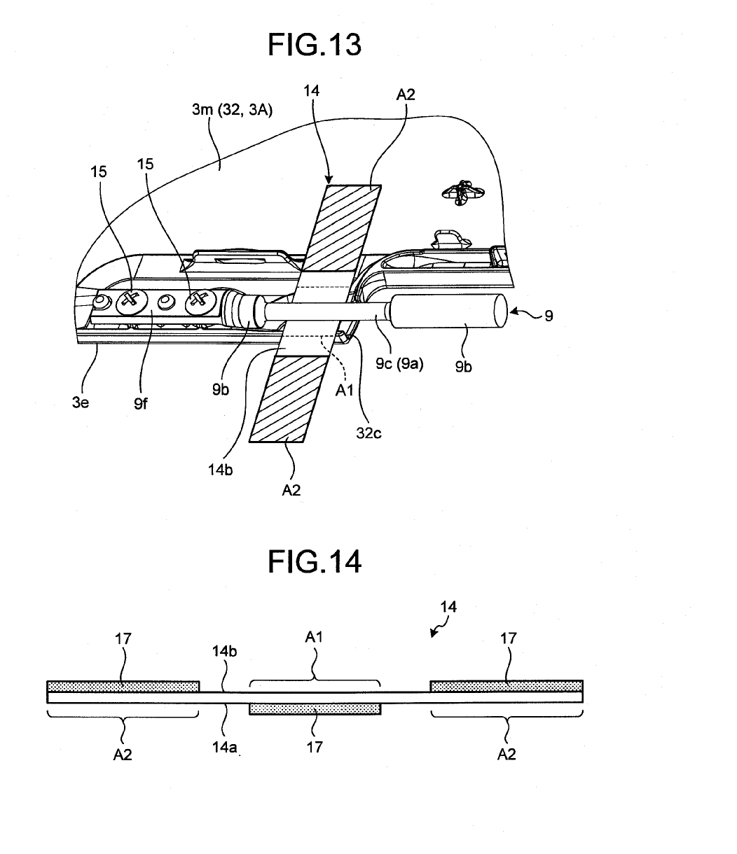

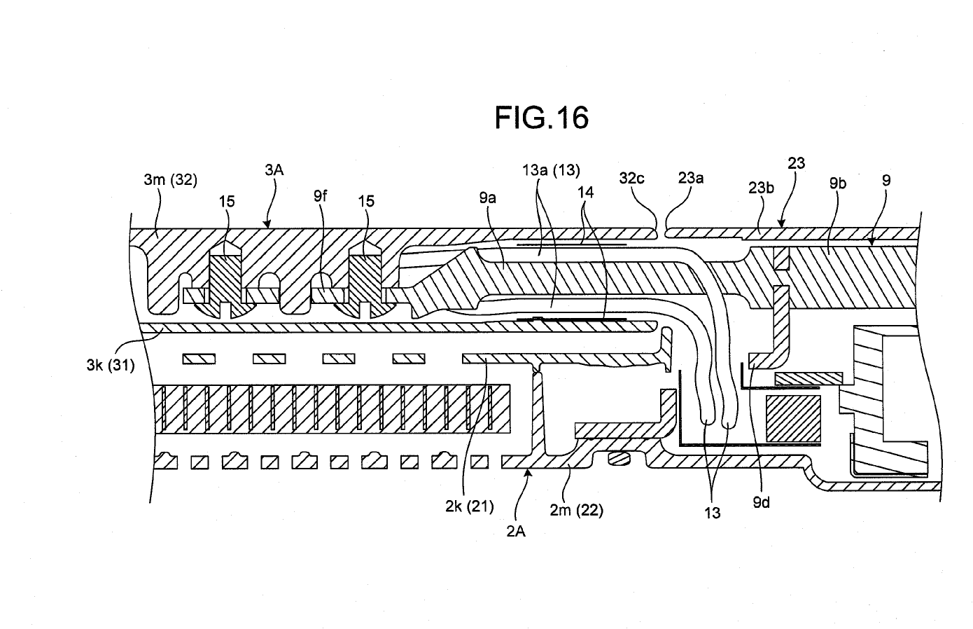

In the present embodiment as well, for example, the harness 13 (a wire) is arranged in a manner extending from the inside of the first housing 3A to the inside of the second housing 2A as illustrated in FIGS. 9 and 10 similarly to the first embodiment. Specifically, for example, the harness 13 electrically connects an electrical component (e.g., the first electrical component, such as the display device 4, the camera module 10, an antenna (not illustrated), and a speaker) provided to the first housing 3A to the board 6A (an electrical component or a circuit) in the second housing 2A, an electrical component (an electronic component) mounted on the board 6A, and an electrical component (a second electrical component) that is accommodated in the second housing 2A and is not mounted on the board 6A. The harness 13 passes through an opening 32c (refer to FIGS. 13 and 16) provided to the first housing 3A, an opening 23a (refer to FIGS. 8 and 16) provided to the second housing 2A, and the like into which the hinge 9 is inserted. In other words, the harness 13 is arranged along the peripheral surface of the shaft 9c of the hinge 9. In the present embodiment, for example, the harnesses 13 include a harness for the display device 4, a harness for the camera module 10, a harness for the antenna, and a harness for the speaker. However, these harnesses are given as examples only, and the harness 13 is not limited thereto.

In the present embodiment as well, for example, the harness 13 is fixed to the hinge 9 with the tape 14 (a holding section, a supporter, a holding component, a connecting component, or a holder) as illustrated in FIGS. 9 and 10. In the present embodiment, for example, the tape 14 bundles the shaft 9c and one or more harnesses 13 arranged around the shaft 9c together from the periphery thereof. Therefore, according to the present embodiment, the harness 13 is prevented from moving near the hinge 9, for example. As a result, it is possible to prevent the harness 13 from being exposed or protruding outward from a boundary (the openings 32c and 23a) between the second housing 2A and the first housing 3A, for example.

In the present embodiment as well, for example, the tape 14 fixes the portion 13a extending along the longitudinal direction of (the shaft 9c of) the hinge 9 in the harness 13. Therefore, according to the present embodiment, it is possible to fix the harness 13 to the shaft 9c with the tape 14 more securely, for example.

In the present embodiment as well, for example, the tape 14 fixes the harnesses 13 arranged along the periphery of the shaft 9c to the shaft 9c. Therefore, according to the present embodiment, it is possible to arrange the harnesses 13 around the shaft 9c more compactly, for example.

In the present embodiment as well, for example, the tape 14 fixes the harness 13 at a position distant from the shaft 9c. Therefore, according to the present embodiment, it is possible to use the tape 14 for fixing (holding) the harness 13 arranged away from the shaft 9c, for example.

In the present embodiment, for example, the tape 14 fixes the harness 13 at a first position P1 near the shaft 9c and at a second position P2 distant from the shaft 9c. Therefore, according to the present embodiment, it is possible to reduce the number of components compared with the case where the harness 13 is fixed with different fixing parts (holding sections), for example. Furthermore, it is possible to reduce trouble when assembling the harness 13, for example.

In the present embodiment as well, for example, the harness 13 is bent between the first position P1 and the second position P2. Therefore, it is possible to fix (hold) the harness 13 extending from the second electrical component of the second housing 2A to the first electrical component of the first housing 3A with one tape 14. In the harness 13, an extending direction at the first position P1 (a direction along the shaft 9c, that is, the left direction in the example of FIG. 9 and the right direction in the example of FIG. 10) is different from (opposite to, in the present embodiment, for example) an extending direction at the second position P2 (the right direction in the example of FIG. 9 and the left direction in the example of FIG. 10).

In the present embodiment as well, for example, the tape 14 is fixed to the first section 9a (shaft 9c) thinner than the second section 9b. Therefore, according to the present embodiment, it is possible to prevent the area in which the harness 13 is fixed to the hinge 9 from becoming larger (becoming bulky), for example. Accordingly, it is possible to increase the flexibility in the layout of the components in the first housing 3A and the second housing 2A, for example.

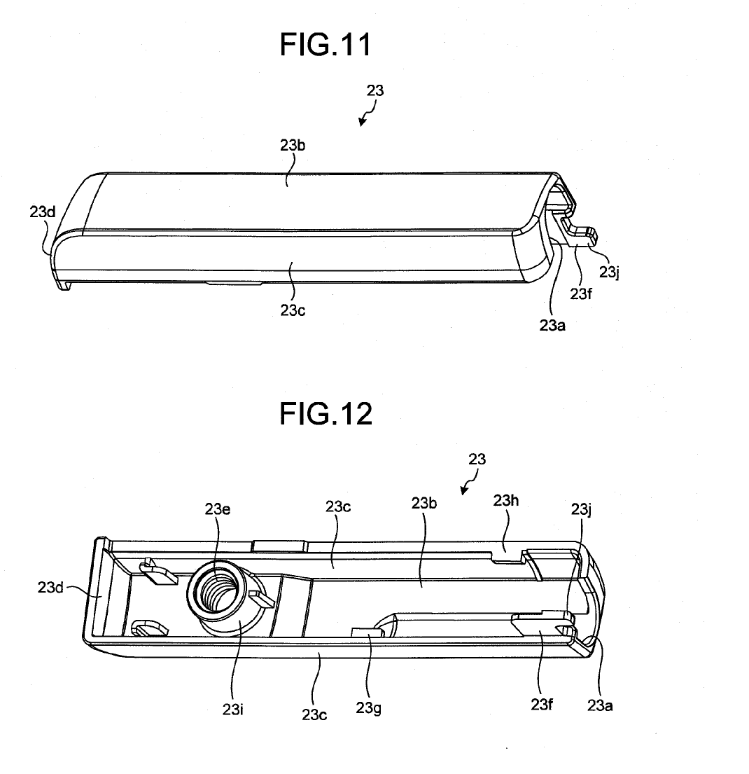

In the present embodiment, for example, the hinge cap 23 has an appearance in a thin rectangular parallelepiped shape extending along the end 2e of the second housing 2A as illustrated in FIGS. 11 and 12. Furthermore, the hinge cap 23 comprises walls 23b, 23c, and 23d. The opposite side of the wall 23b of the hinge cap 23 is open. The wall 23b (a top wall, a topmost wall, or an upper wall) is formed in a rectangular shape (an oblong shape or a strip shape in the present embodiment, for example) and in a plate shape. The wall 23b is provided to a position distant from the surface 2a in a manner extending along the surface 2a (parallel to the surface 2a, in the present embodiment, for example). The walls 23c (side walls) are provided to both ends in the lateral direction of the wall 23b, and protrude in a direction intersecting with the wall 23b (a direction orthogonal to the wall 23b, in the present embodiment, for example). The wall 23c is also formed in a rectangular shape (an oblong shape or a strip shape in the present embodiment, for example) and in a plate shape. The walls 23d are provided to both ends in the longitudinal direction of the wall 23b, and protrude in a direction intersecting with the wall 23b (a direction orthogonal to the wall 23b, in the present embodiment, for example). The wall 23d (a side wall or an end wall) is also formed in a rectangular shape (an oblong shape in the present embodiment, for example) and in a plate shape. The opening 23a is provided to one of the walls 23d (on the center side of the end 2e of the second housing 2A, that is, the side adjacent to the end 3e of the first housing 3A in the present embodiment, for example).

The hinge cap 23 comprises a female screw 23e and engaging sections 23f to 23h as connecting sections. The female screw 23e is provided to a protruding portion 23i (a boss) protruding toward the inside (back side or lower side) of the wall 23b. The female screw 23e is aligned to an opening 2v (e.g., a through-hole or a cutout, which is a through-hole in the present embodiment, for example) provided to the second housing 2A. The opening 2v penetrates the second housing 2A. A fixture such as a screw (not illustrated) inserted into the opening 2v from the lower side (back side or second housing member 22 side) of the second housing 2A is connected to the female screw 23e. As a result, the hinge cap 23 is connected to the second housing 2A (e.g., at least one of the first housing member 21 and the second housing member 22, which is both of them in the present embodiment, for example). Furthermore, the engaging sections 23f to 23h engage with engaging sections 2w to 2y provided to the second housing 2A (e.g., at least one of the first housing member 21 and the second housing member 22, which is the first housing member 21 in the present embodiment, for example). The engaging section 23f protrudes from the wall 23d to which the opening 23a is provided in a direction toward the open side, that is, in a direction toward the wall 2m when the hinge cap 23 is attached to the second housing 2A. The tip (point) of the engaging section 23f is bent in an L shape to form a claw 23j . The claw 23j protrudes toward one side (toward the center of the end 2e in the present embodiment, for example) along the end 2e of the second housing 2A. The engaging sections 23f to 23h are caused to engage with the engaging sections 2w to 2y by: moving the hinge cap 23 in the thickness direction of the second housing 2A so as to come close to the second housing 2A; and moving and sliding the hinge cap 23 toward the center of the end 2e along the end 2e of the second housing 2A (that is, moving the hinge cap 23 in an L-shaped trajectory as illustrated in FIGS. 7 and 8). In the present embodiment, the hinge cap 23 is slid in a direction (a direction along the surface 2a) intersecting with the direction coming close to the second housing 2A to be engaged with the second housing 2A. Therefore, it is possible to increase the area (length) of a portion in which the engaging sections 23f to 23h engage with the engaging sections 2w to 2y compared with a configuration in which the hinge cap 23 is attached by being engaged with the second housing 2A in the direction coming close thereto in association with elastic deformation (that is, a configuration using a snap-fit mechanism), for example. Accordingly, it is possible to increase the connection rigidity and the connection strength (support rigidity and support strength) between the hinge cap 23 and the second housing 2A, for example. In the present embodiment, because the periphery of the hinge 9 is uncovered (exposed) by using the hinge cap 23, the operator can perform the operation of fixing the harness 13 with the tape 14 in a simpler manner.

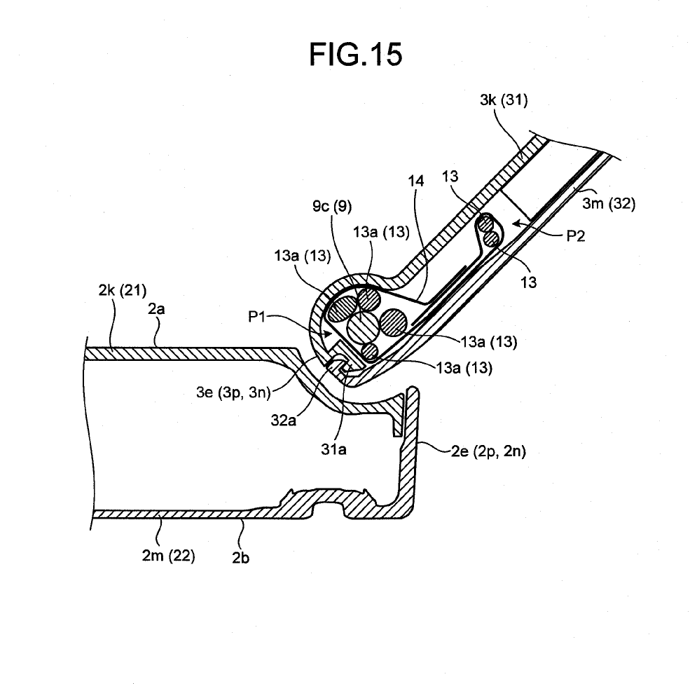

In the present embodiment, for example, the tape 14 is fixed to the second housing member 32 of the first housing 3A in advance as illustrated in FIG. 13. Specifically, the tape 14 is fixed to the second housing member 32 at a position between the shaft 9c and the second housing member 32 in a manner extending in a direction intersecting with the shaft 9c of the hinge 9. As illustrated in FIG. 14, an adhesive agent 17 is applied to a first area A1 in the middle portion (center portion) in the longitudinal direction of a first surface 14a of the tape 14. The first area A1 is stuck to the second housing member 32. Furthermore, the adhesive agent 17 is also applied to second areas A2 on ends in the longitudinal direction of a second surface 14b of the tape 14. The second area A2 is stuck to another portion on the tape 14. In other words, in the present embodiment, for example, the operator folds the end of the tape 14 in the longitudinal direction, and fixes (sticks) the end to another portion on the tape 14 as illustrated in FIG. 15. As a result, it is possible to create a state in which the tape 14 is wound around the shaft 9c and the harness 13 in a relatively simple manner. Furthermore, in the present embodiment, for example, the harness 13 can be fixed with the tape 14 at the first position P1 and the second position P2 as illustrated in FIGS. 9, 10, and 15. At this time, in the present embodiment, for example, one portion of the tape 14 can be fixed (stuck) to another portion thereof with the adhesive agent 17 between the first position P1 and the second position P2. As a result, it is possible to fix the harness 13 with the first position P1 and the second position P2 separated from each other. The first area A1 and the second area A2 are not limited to the example described above, and can be changed in various manners.

In the present embodiment, for example, the tape 14 fixes the harnesses 13 around the shaft 9c as illustrated in FIG. 15. At this time, no harness 13 is arranged in a direction in which an engaging portion of an engaging section 31a of the first housing member 31 and an engaging section 32a of the second housing member 32 is positioned with respect to the shaft 9c. With this configuration, it is possible to prevent the first housing 3A from becoming larger, for example. Furthermore, it is possible to perform the operation of fixing the harness 13 with the tape 14 in a simpler manner, for example.

With such a configuration described above, in the present embodiment, for example, the harness 13 is arranged along the shaft 9c, and is prevented from moving as illustrated in FIG. 16. Therefore, according to the present embodiment, it is possible to prevent trouble caused by movement of the harness 13 from occurring, for example. Furthermore, in the present embodiment, for example, the connector 9f of the hinge 9 is connected to the second housing member 32 of the first housing 3A by a fixture 15 such as a screw as illustrated in FIG. 16. Therefore, the configuration of the first housing 3A can be simpler than a configuration in which the connector 9f is fixed to another component (e.g., a member along the periphery of the display device 4).

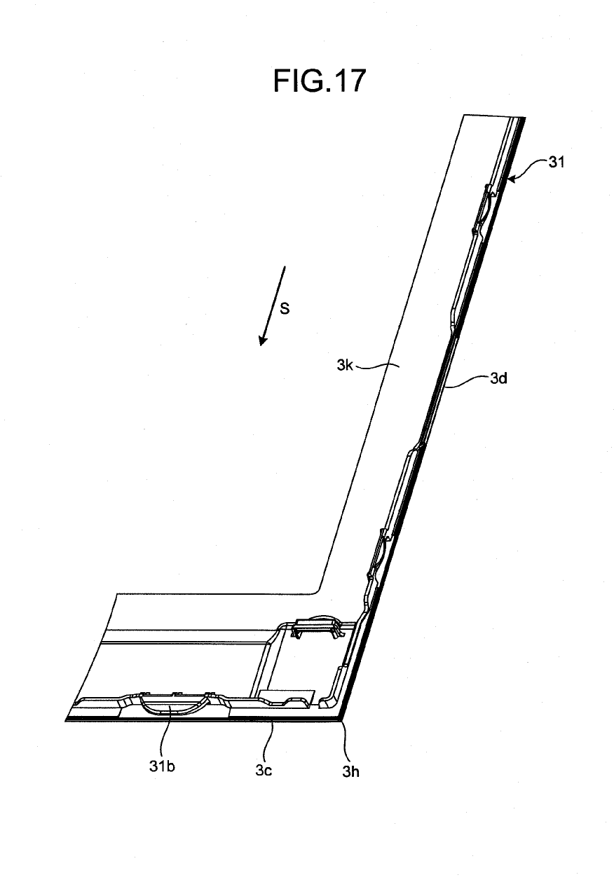

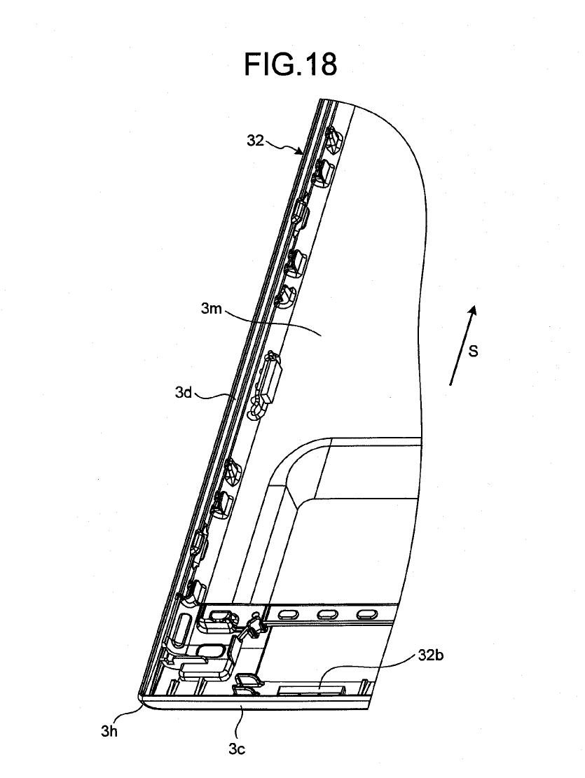

Furthermore, in the present embodiment, for example, the first housing member 31 and the second housing member 32 of the first housing 3A are connected to each other by being slid as illustrated in FIGS. 17 and 18. Specifically, for example, the end 3c of the first housing member 31 is provided with an engaging section 31b protruding toward the edge of the end 3c with a gap interposed between the wall 3k and the engaging section 31b as illustrated in FIG. 17. Furthermore, as illustrated in FIG. 18, the end 3c of the second housing member 32 is provided with an engaging section 32b protruding toward a direction opposite to the protruding direction of the engaging section 31b with a gap interposed between the wall 3m and the engaging section 32b. When assembling the first housing member 31 and the second housing member 32, the operator slides the first housing member 31 and the second housing member 32 in a direction of an arrow S illustrated in FIGS. 17 and 18, thereby causing the engaging section 31b and the engaging section 32b to engage with each other. Therefore, in the present embodiment, it is possible to increase the area (length) of a portion in which the engaging section 31b and the engaging section 32b engage with each other compared with a configuration in which the first housing member 31 and the second housing member 32 are assembled by being engaged with each other in a direction coming close to each other in association with elastic deformation (that is, a configuration using a snap-fit mechanism), for example. Accordingly, it is possible to increase the connection rigidity and the connection strength (support rigidity and support strength) between the first housing member 31 and the second housing member 32, for example.

While certain embodiments have been described, these embodiments have been presented by way of example only, and are not intended to limit the scope of the inventions. For example, the novel receivers and apparatuses described herein may be embodied in a variety of other forms. With another holding section (e.g., a holder, a fixture, a coupler, a connector, a fastener, a bracket, and a synthetic-resin molded component) used instead of a tape, for example, similar results can be obtained. Furthermore, for example, a harness maybe fixed (held, retained, or hooked) around a hinge without being fixed to the hinge with a holder such as a tape. The technological characteristics in the embodiments and the modifications can be combined as appropriate. Furthermore, the specifications (e.g., structure, type, direction, shape, size, length, width, thickness, height, number, arrangement, position, and material) of each of the components can be changed as appropriate.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television receiver comprising:
a display comprising a display screen;
a housing configured to accommodate at least a part of the display, the housing comprising a mask section and a cover section, the mask section comprising an opening through which the display screen is exposed, the cover section covering the display from a side opposite to the display screen;
a support comprising an area facing an external placement surface when the support is on the external placement surface, the support configured to support the housing;
a hinge affixed to the housing and the support, the hinge comprising a rotating shaft, the housing and the support rotatably connected to the hinge about the rotating shaft;
a first electrical component in the housing;
a second electrical component in the support; and
a wire configured to electrically connect the first electrical component and the second electrical component, the wire affixed to the rotating shaft of the hinge with a tape substantially near the support.

2. The television receiver of claim 1, wherein the tape is configured to affix a portion of the wire along a longitudinal direction of the hinge.

3. The television receiver of claim 1, wherein
the wire comprises a plurality of wires arranged along a periphery of the hinge, and
the tape is configured to affix the wires.

4. The television receiver of claim 1, wherein the tape is configured to affix the wire at a position substantially distant from the hinge.

5. The television receiver of claim 1, wherein the tape is configured to affix the wire at a first position and a second position that is more distant from the hinge than the first position.

6. The television receiver of claim 5, wherein the wire affixed with the tape at the first position and the second position is bent between the first position and the second position.

7. The television receiver of claim 1, wherein the tape is affixed to the housing.

8. The television receiver of claim 7, wherein an adhesive is applied to a first area of the tape positioned in a middle portion in a longitudinal direction of a first surface facing the housing and a second area of the tape on a second surface on an opposite side of the first surface.

9. The television receiver of claim 1, wherein
the hinge comprises a first section and a second section that is thicker than the first section, and
the wire is affixed to the first section.

10. The television receiver of claim 1, wherein the hinge is affixed to the housing.

11. The television receiver of claim 1, wherein
the housing comprises a first housing and a second housing, and
at least one of the first housing and the second housing comprises an opening through which the hinge is exposed and a cover configured to cover the opening and the hinge.

12. An electronic apparatus comprising:
a housing configured to accommodate at least a part of a display;
a component connected to the outside of the housing;
a connector configured to connect the housing and the component; and
a wire held to the connection by a holding section along a direction in which the connection extends.
